(19) United States
(12) Patent Application Publication
(10) Pub. No.: US 2016/0224533 A1
(43) Pub. Date: Aug. 4, 2016

(54) SEARCH ENGINE BUTTONS MATRIX INTERFACE

(71) Applicant: Sunil Gopalchandra Samanta, Tarrytown, NY (US)

(72) Inventor: Sunil Gopalchandra Samanta, Tarrytown, NY (US)

(21) Appl. No.: 14/919,719

(22) Filed: Oct. 21, 2015

Related U.S. Application Data
(60) Provisional application No. 62/109,562, filed on Jan. 29, 2015.

(51) Int. Cl. G06F 17/24; G06F 3/0482

(52) U.S. Cl. CPC G06F 17/245; G06F 3/0482

(57) ABSTRACT

A standalone computing device's user interface or a compliant website, password protected intranet, password protected extranet, software or any other user interface (one that has adopted this interface and presents its hyperlinks in a buttons matrix) pre-populates information resources or populates information resources based on input keywords. This search engine buttons matrix interface provides greater control to the users in availing information resources from backend or reorganizing information resources output in ways preferred by the user rather than by the search engine providers.

### CROSS-REFERENCE TO RELATED APPLICATION

This application claims the benefit of provisional patent application No. 62/109,562 filing date Jan. 29, 2015 titled SEARCH ENGINE MATRIX INTERFACE.

### FEDERALLY SPONSORED RESEARCH

None.

### SEQUENCE LISTING

None.

### REFERENCE . . . PAGE NUMBER

TITLE PAGE . . . 1
INDEX . . . 2
BACKGROUND . . . 4
BRIEF SUMMARY OF THE INVENTION . . . 10
BRIEF DESCRIPTION OF DRAWINGS . . . 11
DETAILED DESCRIPTION OF THE INVENTION . . . 14
REFERENCE NUMERALS . . . 20
OPERATION . . . 22
claims . . . 26
ABSTRACT . . . 29
FIGURES . . . 30
FIG. 1 Part 1 and FIG. 1 Part 2 . . . 30
FIG. 2 Part 1 and FIG. 2 Part 2 . . . 31
FIG. 3 Part 1 and FIG. 3 Part 2 . . . 32
FIG. 4 Part 1 and FIG. 4 Part 2 . . . 33
FIG. 5 Part 1 and FIG. 5 Part 2 . . . 34
FIG. 6 Part 1 and FIG. 6 Part 2 . . . 35
FIG. 7 Part 1 and FIG. 7 Part 2 . . . 36
FIG. 8 Part 1 and FIG. 8 Part 2 . . . 37
FIG. 9 Part 1 and FIG. 9 Part 2 . . . 38
FIG. 10 Part 1 and FIG. 10 Part 2 . . . 39
FIG. 11 Part 1 and FIG. 11 Part 2 . . . 40
FIG. 12 . . . 41

### BACKGROUND

1. Prior Art

The following is a tabulation of some prior art that presently appears relevant:
U.S. Patent

### Patent Number Kind Code Issue Date Patentee

U.S. Pat. No. 8,121,997 B2 Feb. 21, 2012 Nathan F. Raciborski/Limelight Networks, Inc.
U.S. Patent Application Publications
   Publication Number Kind Code Pub. Date Applicant

### US 2009/0019348 A1 Jan. 15, 2009 Rodney Kuhn Haffnerson King

### US 2007/0299830 A1 Dec. 27, 2007 Christopher Muenchhoff, Yevgeniy Lukyanov

### US 2006/00277167 A1 Dec. 7, 2006 William Gross, Lee Hasiuk, Thomas McGovern, Jason D. Levine

International Publication
   Application Number Kind Code Pub. Date Applicant

### WO 01/77893 A1 18 Oct. 2001 YOUN, Sung-Won

Popular Search Engines
   http://www.google.com
   http://www.bing.com
   http://search.yahoo.com/

This patent application relates to a search engine buttons matrix interface for a dedicated website or hyperlinked to a compliant user interface (any website, password protected intranet, password protected extranet, software or any user interface that has adopted this interface and presents its hyperlinks in a buttons matrix) for displaying or extracting information resources available on the Internet or intranet or extranet or any computer networks or on any computing device or on software accessed using any computing device (client, printer, server, router, switch or any other connecting node) that provides both input and output features. This interface allows users to input keywords and search information resources or hyperlinked resources to further extract information resources or use information resources that are displayed to them before even inputting keyword(s) for information resources. A user can view or extract information resources in ascending or descending order; view or extract information resources as provided in different categories such as in the library classifications systems; view or extract names of countries in the world that are relevant to a user; view or extract information resources that are presented in the order of their popularity in the country that a user may be interested in; view or extract information resources that a user may most recently or frequently or mostly (time spent wise) be using; view or extract information resources that all the users may most recently or frequently or mostly (time spent wise) be using; view or extract information resources at the next level of details like instead of just alphabetical listing, view or extract information resources on a particular alphabet in ascending or descending order. More command buttons of interest to users will be added as required such as images, videos, news, maps, travel, hotels, shop, weather, finance, music, horoscope, dating, exercise, yoga, weight loss, health, restaurants, politics, education, and user defined or user configured command buttons. Buttons may contain appropriate shapes, colors, shades, designs to help users navigate as well as for aesthetic appeal including logos or icons. Buttons may also contain labels of numbers based on appropriate logic that can be invoked using voice command. Buttons can be partitioned with shades allowing users to select different shades to either go to search website directly or to go to next level of detailed buttons matrix organized on tree logic available on the site map of such a website.

A command button will enable users to configure the shapes, designs, colors, shades, themes of buttons or background. Buttons will show up a preview bubble with brief details on each button if cursor is moved over a button or if invoked by a speech command.

Buttons to advertise websites or products or services may be added with or without distinct shapes, designs, colors or looks.

Such interface can be made manually, by using software, or in a mixed manner.

Prior art U.S. Pat. No. 8,121,997 (2012); and U.S. Patent Application Publications US 2009/0019348, US 2007/0299830, US 2006/00277167; and International Publication WO 01/77893 were found while doing search on user search engine buttons matrix interface.

International Publication WO 01/77893 is about a method of displaying results of Internet search engine that includes an input text-field and a search button that displays a search result in a polygonal manner. This has a problem that a user cannot order or reorder the search result in the manner she may like to.

U.S. Patent Application Publications US 2006/00277167 is about a method that uses an input text-field and search button and provides the search result that uses the list area to display a list of search results adopted to display one or more pre-loaded web pages in a matrix format as per user's selection. This has a problem that a user cannot order or reorder the search result in the manner she may like to and that users can see only one or, if more, a few pre-loaded web pages.

U.S. Patent Application Publications US 2007/0299830 is about a method for displaying a search result images rendered in rectangular portion of a grid layout scaled to the size of the window. This has a problem that a user cannot order or reorder the search result in the manner she may like to. Also a user cannot find all outcomes of the search on one page.

U.S. Patent Application Publications US 2009/0019348 is about a method where the information is displayed according to a fractal grid hierarchy that consists of multiple levels of resolution. Each level of a fractal grid hierarch displays one or more cells in a nine-cell grid fashion. This has a problem that a user cannot order or reorder the search result in the manner she may like to. Also a user cannot see all the outcomes of the search on one page.

U.S. Pat. No. 8,121,997 (2012) is about a search system for searching both intranet datasets and Internet datasets with a single search interface that includes a first interface portion having input text-field and a search button that receives a search query from the end user. It also allows that the preference is modifiable by the end user. The modification, though, that the user can do is about a preference for a target search engine referenced by the search query. The selected input syntax is one of a plurality of sets of input syntaxes, for operators and/or for Boolean operations, that translates the search query with the user selected input syntax for searching intranet datasets and/or Internet datasets where in the search query is defined by at least one of: entry of a text string into a command line interface; and manipulation of a graphical user interface. The modification of the preference changes the target search engine or plurality of target search engines to be searched. The target search engine cannot be determined from the search query alone. The problem with this system is that a user can provide a preference or modify it but just for a target search engine referenced by the search query. A user cannot order or reorder the search result in the manner she may like to. Also a user cannot see all the outcomes of the search on one page.

The popular search engine http://google.com provides an input text-field and a search button or two to enable a user to search for information resources. The search results presented though are as per Google's logic that does not take into account a user's preference for how the search result is presented to her or how she may like to further reorder them.

Similarly http.//bing.com too provides an input text-field and a search button to enable a user to search for information resources. Additionally, it also provide some menus with menu-items for popular search topics but the search results presented though are as per Bing's logic that does not take into account a user's preference for how the search result is presented to her or how she may like to further reorder them.

The popular search engine http://search.yahoo.com/ provides an input text-field and a search button to enable a user to search for information resources. Additionally, it is a portal that dispenses hyperlinks to popular search topics and also provide some menus with menu-items for popular search topics but the search results presented though are as per Yahoo's logic that does not take into account a user's preference for how the search result is presented to her or how she may like to further reorder them.

Collectively all these prior arts relate to presenting search results in a fractal grid matrix or in a polygonal manner, making use of graphical controls including menus, list boxes, action buttons, sliders and radio buttons, search result preference modifiable by the end user, and a number of web pages displayed concurrently. But no search engine interface provides input features along with output features to start with to empower unsophisticated Internet users to explore information resources that are available on the networks even without being aware of the search keywords as the system proposed by this application does. Some do have tabs, buttons, or hyperlinks labeled such as image, video, news, local, shopping, white pages but none provides comprehensive information resources that can be drilled down or drilled up the way the proposed system of search engine buttons matrix interface does. This is further evident by the distinctive claims made by this patent application.

### BRIEF SUMMARY OF THE INVENTION

A novel search engine buttons matrix interface displays or extracts and presents in an organized manner to the information seekers what information resource do they need. Additionally it also provides pre-searched information resources that are likely to be useful to multitude of users as per the predetermined logics provided through the use of buttons and other Graphical User Interface (GUI) controls. The information resources can be manipulated as per user's preferences. Users' favorite websites and visited websites are tracked through the use of cookies and/or client and server based distributed databases to help individual user and all users to access them. Information resources that are out of sight are out of mind. In a nutshell, the focus of this patent is not as much on the users as much as on the information resources to be brought forth from the backend to the frontend in a proactive manner enabling the users of Internet/intranet/extranet/software/computer networks/any other user interface to avail information resources in a user friendly manner.

### Advantages

Accordingly several advantages are to provide search results, proactively organized on certain logics, from the Internet/intranet/extranet/software/computer networks/any other user interface and that the users will be able to manipulate the information resources in the manner they desire. Further advantages will become apparent from a study of the following description and the accompanying drawings.

### BRIEF DESCRIPTION OF DRAWINGS

FIG. 1 (Part 1 and Part 2) is a perspective of the search engine buttons matrix interface at location 11. Top row has function buttons and an input box. The left most column consists of ordering or sorting buttons. The information resources presented are in a default ascending order.

FIG. 2 (Part 1 and Part 2) is a default local perspective of the search engine buttons matrix interface at location 11. The information resources presented are more detailed ones all based on alphabet ‘A’.

FIG. 3 (Part 1 and Part 2) is a perspective of the search engine buttons matrix interface at location 11. The information resources presented are in descending order after the button labeled “Sort ZA” at location 19 is selected.

FIG. 4 (Part 1 and Part 2) is a perspective of the search engine buttons matrix interface at location 11. The information resources presented are in categories as per the library classifications systems after the “Library” button at location 20 is selected.

FIG. 5 (Part 1 and Part 2) is a perspective of the search engine buttons matrix interface at location 11. The names of countries of the world are presented in alphabetical order as search results after the button labeled “World” at location 21 is selected.

FIG. 6 (Part 1 and Part 2) is a perspective of the search engine buttons matrix interface at location 11. The search results are diagonally, with most popular in the top left corner and the least popular in the bottom right corner, presented in the decreasing order of popularity in the

United States after the search result button labeled “USA” in FIG. 5 is selected.

FIG. 7 (Part 1 and Part 2) is a perspective of the search engine buttons matrix interface at location 11. The information resources presented are the information resources in the decreasing order frequencies of personal usage by a user presented diagonally with most used buttons at the top left corner and least used buttons at the bottom right corner after the button labeled “User's” at location 22 is selected.

FIG. 8 (Part 1 and Part 2) is a perspective of the search engine buttons matrix interface at location 11. The information resources buttons presented are the hyperlinks on a compliant (one that has adopted this interface and presents its hyperlinks in a matrix) website as per the design of the website (i.e. www.devey.edu).

FIG. 9 (Part 1 and Part 2) is a perspective of the search engine buttons matrix interface at location 11. The information resources presented are the information resources or hyperlinks on a website in the decreasing order of popularity in a domestic country (i.e. the US) grouped in alphabetical order after the button labeled “Users” at location 23 is selected.

FIG. 10 (Part 1 and Part 2) is a perspective of the search engine buttons matrix interface at location 11. The information resources presented are the hyperlinks on a compliant (one that has adopted this interface and presents its hyperlinks in a matrix) website i.e. www.devry.edu in the decreasing order of popularity of the hyperlinks among all users presented diagonally with most used buttons at the top left corner and least used buttons at the bottom right corner.

FIG. 11 (Part 1 and Part 2) is a perspective of the search engine buttons matrix interface at location 11. The information resources are the hyperlinks or in an intranet or in extranet protected by password as per its design i.e. a distance learning intranet after a user logs into it. Users will be granted option to save user name and password so that is transitioned directly inside of a password protected intranet or extranet after selecting a button such as one labeled “course shell” in FIG. 7.

FIG. 12 is a close-up perspective of the search engine button at location 31. This search button has two parts—left at location 32 and right at location 33. Depending on which row and column it may appear in an interface it would have alphanumeric notation i.e. 23L (2^{nd} row, 3^{rd} column on left) as shown at location 32 in color along with the name of the business i.e. amazon. Logo at location 34 and alphanumeric notation i.e. 23R (2^{nd} row, 3^{rd} column on right) as shown at location 33 on the right side in different color. Mouse curser is shown at location 36. A preview bubble is shown at location 36. Another button that shows similar details but in the 3^{rd} row and 3^{rd} column is shown for ebay at location 37. A blank button is shown at location 38. The button shown at location 39 is with distinct colors compared to other buttons. That indicates that such button is the button sponsored by advertiser i.e. barnes & noble.

### DETAILED DESCRIPTION OF THE INVENTION

Popular web technologies can be used to develop this interface linked to databases that has pre-searched, pre-ordered and pre-sorted information resources and users' information search tracking. Effective and efficient web technologies like Java®, HTML5, CSS, XML, Javascript, JQuery, JSON, SQL, MySQL, NoSQL and cloud computing will be used to develop this interface and connected databases.

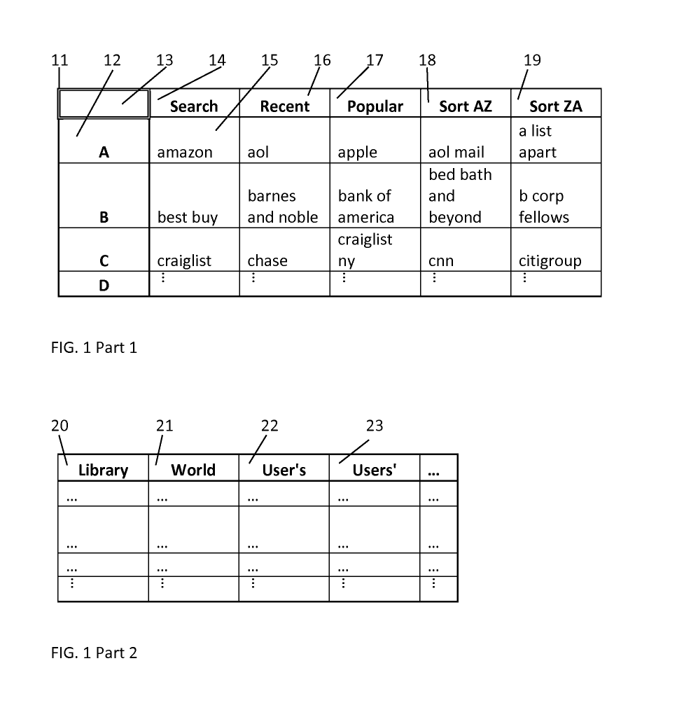

FIG. 1 (Part 1 and Part 2) is a perspective of the search engine buttons matrix interface at location 11 constructed in accordance with one embodiment. Top row has an input box and command buttons. The left most column consists of buttons labeled alphabetically (or numerically in some other FIGS.) The information resources keywords are displayed in a default ascending order as buttons or hyperlinks or information resources in the decreasing order of popularity in a relevant locality e.g. a country. An input box is at the location 13 that allows a user to input keywords for search. A button at location 14 is with a label “Search”. After entering keywords, a user needs to select the “Search” button at location 14 either by clicking on it or touching it or invoking voice command or hitting the “Enter” button on a keyboard to view or extract the search results. The column of buttons at location 12 labeled alphabetically or numerically allows a user reorder information resources keywords to the next level of details or with decreasing order of usage or popularity. The button at location 18 with a label “Sort AZ” is for sorting the information resources in ascending order in the matrix of rows and columns as the labels of buttons or hyperlinks or information resources with the top left button or cell located at 15. The button at location 19 with a label “Sort ZA” is for sorting the same information resources in descending order. The button at location 20 with a label “Library” provides the information resources in a tree format organized such as in the library classifications systems. The button at location 21 with a label “World” provides a list of names of countries in alphabetical order. The button at location 22 with a label “User's” provides the information resources in the decreasing order of usage by a user. The button at location 23 with a label “Users” provides the information resources in the decreasing order of usage by all users.

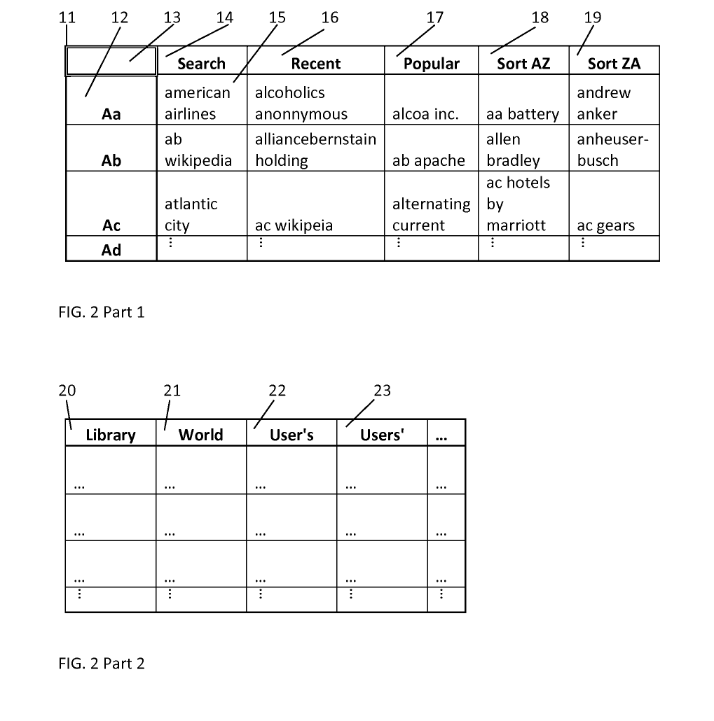

FIG. 2 (Part 1 and Part 2) is a perspective of the search engine buttons matrix interface at location 11. The information resources presented are more detailed alphabetically all starting with alphabet ‘A’. This is extracted and presented after the button labeled ‘A’ at location 12 as shown in FIG. 1 (Part 1 and Part 2) is selected by clicking on it or touching it or by speech command or in any other manner. If the button labeled “Ab” at location 12 in FIG. 2 (Part 1 and Part 2) is selected the information resources will be presented with more detailed alphabetical order with all words starting with alphabets “Ab”. Similar logic will follow going to the next level of details for each button in the column at location 12.

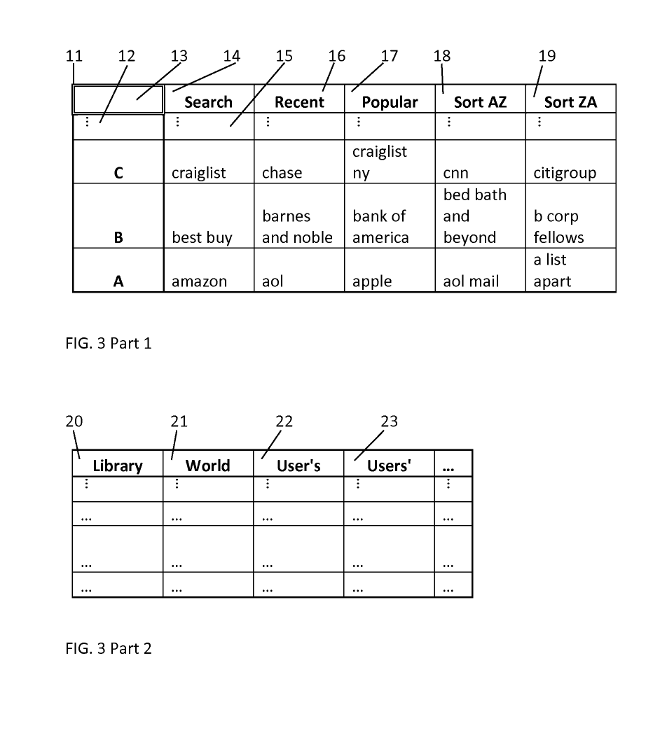

FIG. 3 (Part 1 and Part 2) is a perspective of the search engine buttons matrix interface at location 11. The information resources presented are in a descending order after the “Sort ZA” button at location 19 is selected in FIG. 1 (Part 1 and Part 2).

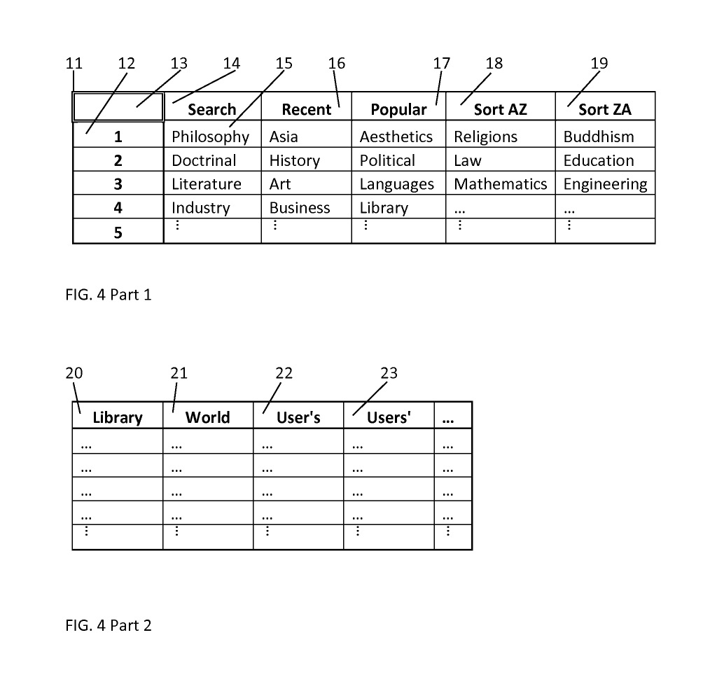

FIG. 4 (Part 1 and Part 2) is a perspective of the search engine buttons matrix interface at location 11. The information resources presented are in the categories as per the library classifications systems after the “Library” button at location 20 is selected. After a user selects any classification button the interface would then populate information resources that are series of sub-classifications until finally a resource topic is displayed for a user to extract information from.

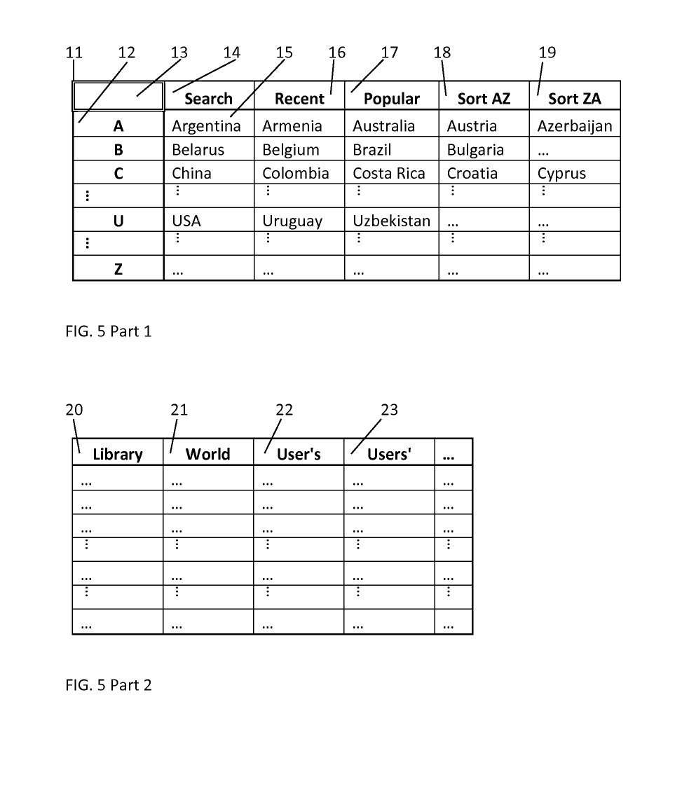

FIG. 5 (Part 1 and Part 2) is a perspective of the search engine buttons matrix interface at location 11. The names of countries of the world are presented in alphabetical order as search results after the “World” button at location 21 is selected.

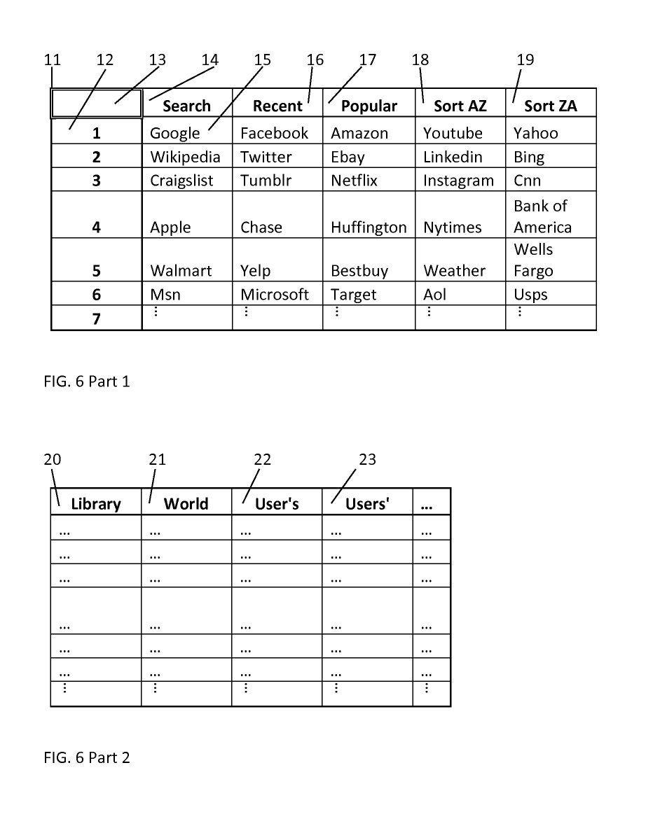

FIG. 6 (Part 1 and Part 2) is a perspective of the search engine buttons matrix interface at location 11. The search results presented are the relevant information resources in the decreasing order of popularity in the USA after the “USA” button in FIG. 5 (Part 1 and Part 2) is selected.

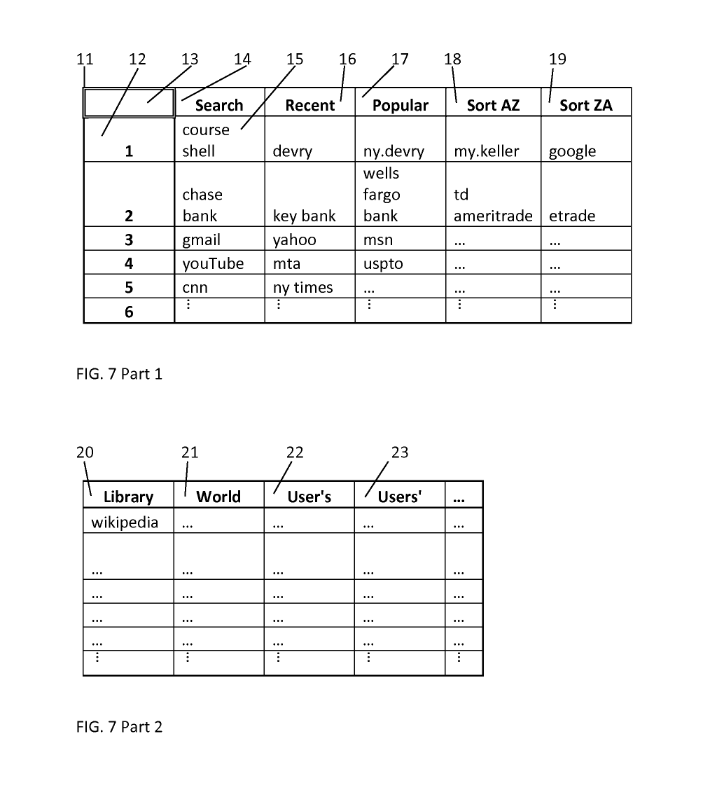

FIG. 7 (Part 1 and Part 2) is a perspective of the search engine buttons matrix interface at location 11. The information resources presented are the information resources or hyperlinks in the decreasing order of frequencies of personal usage by a user presented diagonally with most used buttons at the top left corner and least used buttons at the bottom right corner after the “User's” button at location 22 in FIG. 1 (Part 1 and Part 2) is selected.

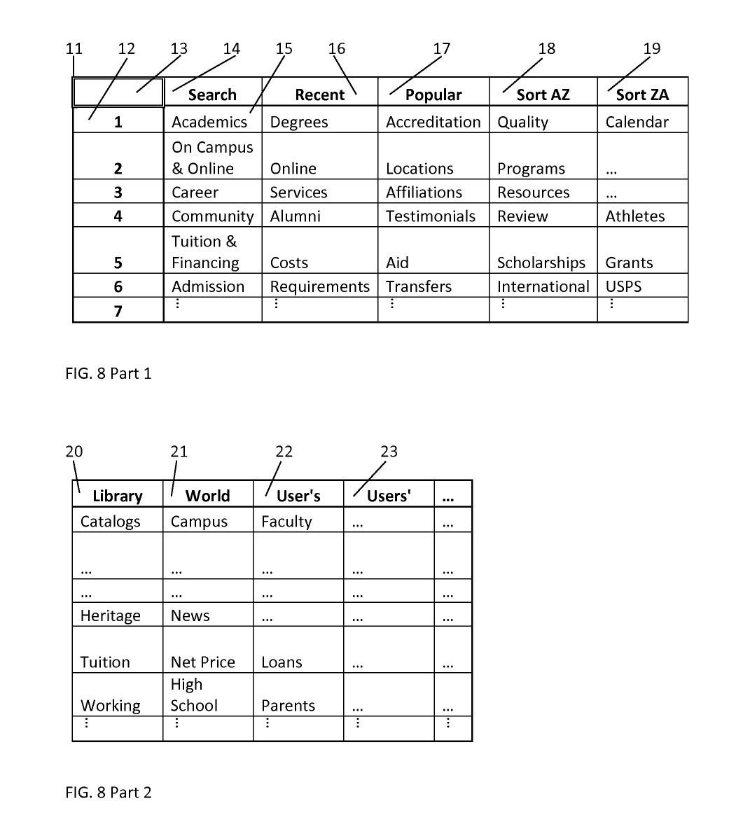

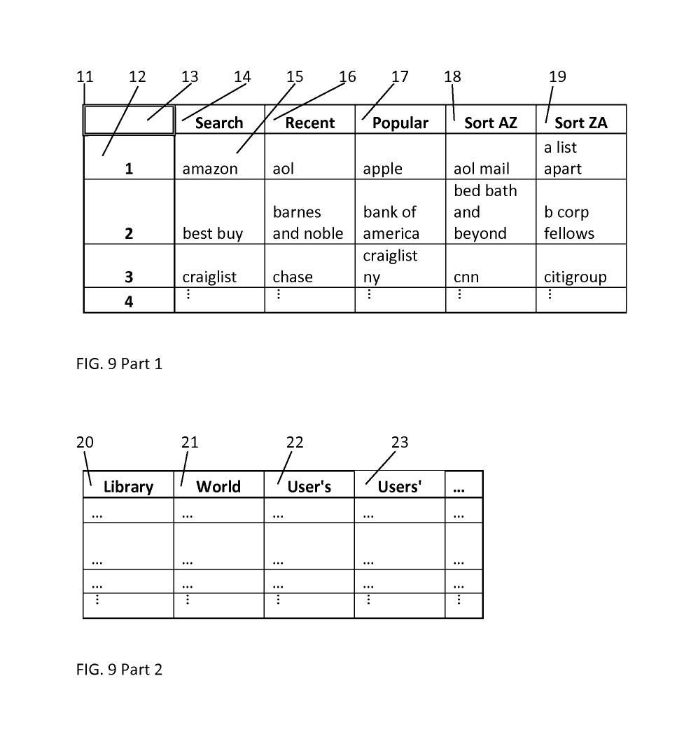

FIG. 8 (Part 1 and Part 2) is a perspective of the search engine buttons matrix interface at location 11. The information resources presented are the buttons or hyperlinks of a compliant website as per the design of the website i.e. www.devry.edu after the “devry” button from FIG. 7 (Part 1 and Part 2) is selected. FIG. 9 (Part 1 and Part 2) is a perspective of the search engine buttons matrix interface at location 11. The information resources presented are the relevant information resources as buttons or hyperlinks in the decreasing order of popularity in a domestic country (i.e. the US) grouped in alphabetical order after the “Users” button at location 23 from FIG. 1 (Part 1 and Part 2) is selected.

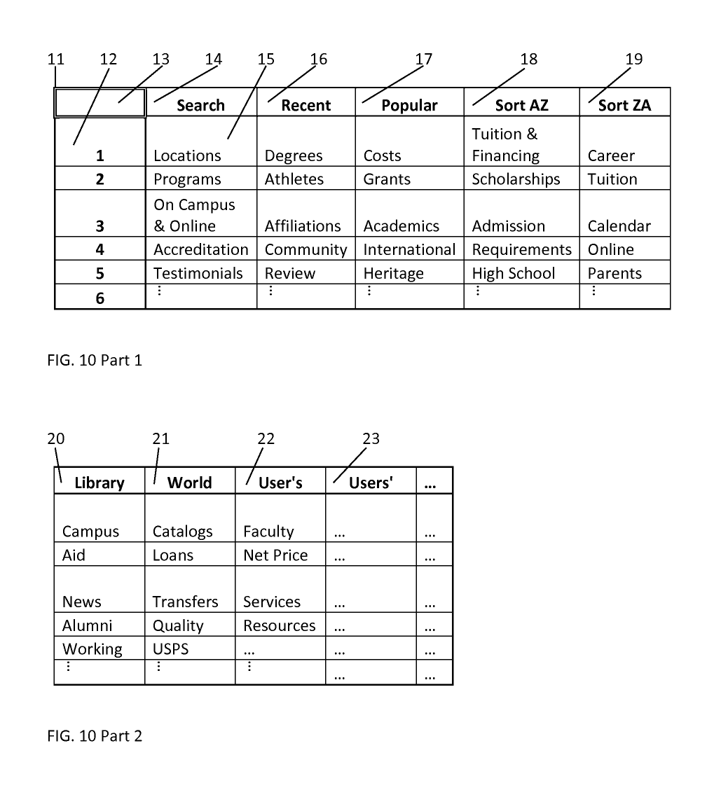

FIG. 10 (Part 1 and Part 2) is a perspective of the search engine buttons matrix interface at location 11. The information resources diagonally presented are the hyperlinks on a website i.e. www.devry.edu in the decreasing order of frequency of usage or decreasing popularity of the hyperlinks among all users after the “Users” button at location 23 in FIG. 8 (Part 1 and Part 2) is selected.

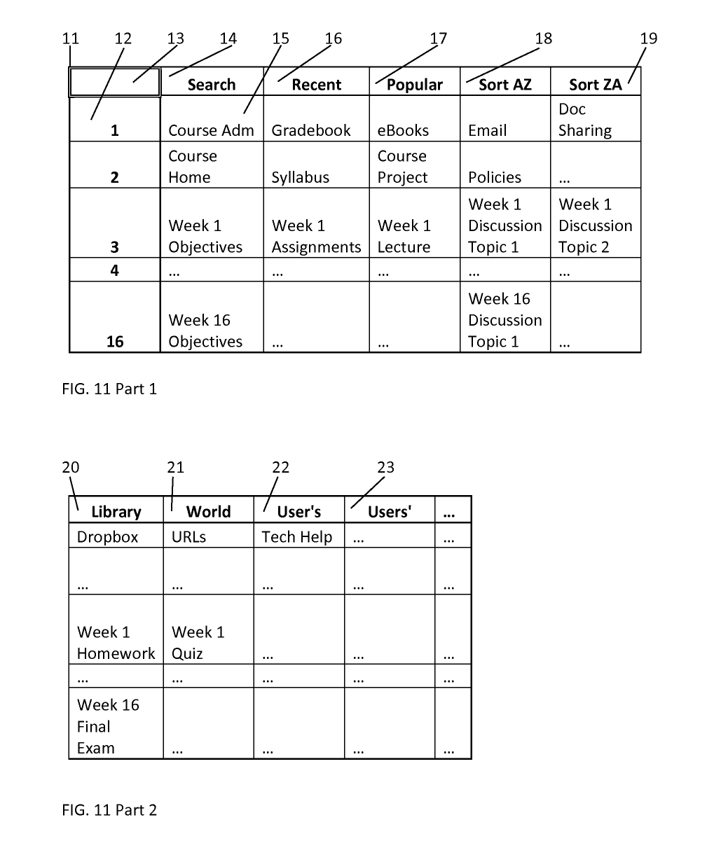

FIG. 11 (Part 1 and Part 2) is a perspective of the search engine buttons matrix interface at location 11. The information resources presented are the hyperlinks on a website or in an intranet or in extranet as per the design of the website (i.e. a distance learning intranet) after the “course shell” button from FIG. 7 (Part 1 and Part 2) is selected.

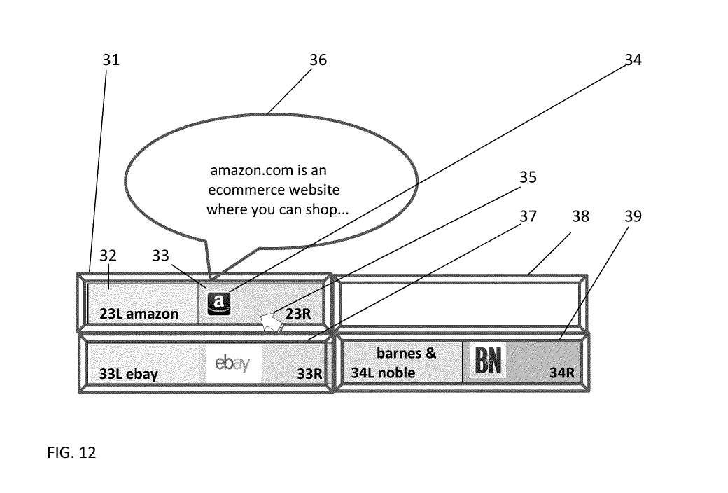

FIG. 12 is a close-up perspective of the search engine button at location 31. This search button has two parts—left at location 32 and right at location 33. If a user clicks on part of the button at 32 it would take the user to the website of the respective company i.e. http://amazon.com in this case. But if that website is a compliant one and if the user clicks on part of the button at 34 it would transition the user to another button matrix interface that populates buttons hyperlinked to hyperlinks at http://www.amazon.com. Depending on which row and column it may appear in an interface it would have alphanumeric notation i.e. 23L (2^{nd} row, 3^{rd} column on left) as shown at location 32 in color along with the name of the business i.e. amazon. Logo at location 34 and alphanumeric notation i.e. 23R (2^{nd} row, 3^{rd} column on right) as shown at location 33 on the right side in different color. A user using voice command will be able to recite alphanumeric notation 23L or 23R to navigate to respective button. Mouse curser is shown at location 36. If a user hovers mouse curser anywhere on the button at 31 a preview bubble as shown at location 36 would pop up. A user using voice command will get it if recites “23 preview” meaning show the preview for the button at location at 2^{nd} row and 3^{rd} column and same preview will show up. Another button that shows similar details but in the 3^{rd} row and 3^{rd} column is shown for ebay at location 37. A blank button is shown at location 38. That indicates that it is unavailable at no relevant information resources may be available at such location following certain logic. The button shown at location 39 is with distinct colors compared to other buttons. That indicates that such button is the button sponsored by advertiser i.e. barnes & noble.

These information resources from any FIG. can be re-sorted such as by the order of recent use or frequency of use by the user or frequency of use by the users, in ascending order, in descending order, and by any classifications or sub-classifications.

More function or command buttons or any other Graphical User Interface (GUI) components may be added to further help users extract or order information resources from the Internet/intranet/extranet/software/computer networks/any other user interface. The function or command buttons may be redesigned or relocated doing the same, similar or other functions.

Most search engines take in input of keywords and provide information as per certain logics they follow but do not provide functionalities at the disposal of the users to explore the information resources available on a standalone or a networked computing device. This invention provides information resources to users in organized manner and grants power to manipulate the information resources in the manner they would like to see and explore. The innovation is simple and not difficult to make by anyone who is in the profession of web and database making and data processing.

### REFERENCE NUMERALS

11. search engine buttons matrix interface
12. column of buttons in alphabetical order or numerical order
13. search keywords input box
14. button labeled “Search” for extracting and presenting the search results
15. information resources or search results as the buttons matrix or hyperlinks in rows and columns
16. button labeled “Recent” for extracting and presenting information resources in the order how recently the information resources were accessed by a user
17. button labeled “Popular” for extracting and presenting information resources in the order how frequently the information resources were accessed by a user or users
18. button labeled “Sort AZ” for presenting information resources in an ascending order
19. button labeled “Sort ZA” for presenting information resources in a descending order
20. button labeled “Library” for presenting library classifications or information resources in categories as per the library classifications systems
21. button labeled “World” for presenting buttons with labels of names of countries in the world
22. button labeled “User's” for presenting information resources in the decreasing order of usage frequency by a user
23. button labeled “Users” for presenting information resources in the decreasing order of usage by all users
31. button is a close up of the button for ‘amazon’
32. button is a close up of left part of the button for ‘amazon’
33. button is a close up of right part of the button for ‘amazon’
34. is the logo for amazon button
35. is the mouse cursor
36. is a preview bubble for ‘amazon’ button
37. a close up of a button for ‘ebay’
38. a close up of a blank button
39. is a close up of a button for ‘barnes & noble’ that is a sponsoring advertiser that has distinct colors

### Operation

In operation, one uses the search engine buttons matrix interface either as a standalone website such as www.google.com and www.bing.com for searching information resources on the web or on any computing device or on any software or on any user interface through mainframe computers' terminals, desktop computers, mobile computers such as laptop/notepad, eReaders, smartphone or any other computing device including the Internet of Things (IoT) devices, wearable technology devices.

This interface can also be embedded fully or partially in any other website. A tab, a button or hyperlink or other means to access this interface can be provided on such a compliant website, password protected intranet, password protected extranet, software or user interface (one that has adopted this interface and presents its hyperlinks in a matrix) accessed using any computing device, like a client computer, printer, server, router, switch or any other connecting node, that provides both input and output features. When one selects that option by clicking on it or by touching it or through other manner including voice interface a window of this interface pops up or a user is transitioned to this interface as found appropriate.

The interface connects a user to a centralized or decentralized database on a server or a client or any other computing device that has stored results in advance. I will develop appropriate search engine or procure it and use it to extract information resources as search results. The information resources may be truncated in meaningful keywords as labels for buttons or hyperlinks displayed in a matrix. By default it would display relevant perspective of the search engine buttons matrix interface as shown in FIG. 1 (Part 1 and Part 2) at location 11. But when accessed again after using it for the first time it would open up the interface viewed last or would default to user's pre-configured preference. User can use one of the following operations at any time and in any sequence to view or extract relevant information resources or search results a user may be interested in.

1. The search results are displayed in an array or a vector of buttons or hyperlinks that keeps expanding both horizontally to the east and vertically to the south of the window on the screen. A user can scroll to the relevant place and select a button or a hyperlink to go to the Uniform Resource Locator (URL) one is interested in or go to the next level of detailed buttons on such URL.

2. If the relevant search result that a user may be interested in is not displayed in the initial screen or a user wants to save time and effort of scrolling, can enter search keywords in the input box at location 13 and select “Search” button at location 14 to view or extract targeted search results.

3. If a user would like to go to the next level of details from FIG. 1 (Part 1 and Part 2) or any other FIGS, can select any of the alphabetically or numerically labeled buttons on the left most column. If a user selects alphabet ‘A’ would then transition to the interface as shown in FIG. 2 (Part 1 and Part 2). User may select any of the given options to continue going to next level of details by clicking on the alphabetical or numerical buttons or hyperlinks on the left most column.

4. From FIG. 1 (Part 1 and Part 2) or any other FIGS if a user may like to sort the information resources in descending order can select button labeled “Sort ZA” at location 19 to view or extract output similar to FIG. 3 (Part 1 and Part 2). To sort the information resources again in ascending order a user can select “Sort AZ” labeled button at location 18 to view or extract output similar to FIG. 1 (Part 1 and Part 2).

5. If a user would like to explore information resources or search results in categories such as in the library classifications systems, can select “Library” button at location 20. The search results presented are in categories as per the library classifications systems until finally a resource is displayed for the user to extract information from.

6. A user may select the button at location 21 with a label “World” to view or extract a matrix of buttons with labels of names of countries in alphabetical order row-wise.

7. A user may select the button at location 22 with a label “User's” to view or extract the information resources in the decreasing order of frequencies of usage by the user.

8. A user may select the button at location 23 with a label “Users” to view or extract the information resources in the decreasing order of frequencies of usage by all users.

9. The user may change the order of the information resources from any of about steps, where applicable, in the order of how recently were they accessed by selecting the button labeled “Recent” at location 16, in the order of how frequently were they accessed by selecting the button labeled “Popular” at location 17, and in ascending or descending order by selecting “Sort AZ” button at location 18 or “Sort ZA” button at location 19, respectively.

10. More command buttons or Graphical User Interface (GUI) components of interest to users will be added as required enabling users also to explore more resources or reconfigure the interface to match personal taste.

11. Buttons labels may also contain numbers based on appropriate logic that can be invoked using voice command. Buttons will be shaded allowing users to select different shades to either go directly to a search website or to go to the next level of detailed buttons matrix organized on a tree logic consisting of the hyperlinks on such a website. Buttons will show up a preview bubble with brief details on each button if cursor is moved over a button or if invoked by a speech command.

What is claimed is:

1. A search engine buttons matrix interface that displays or presents reorganized information resources on the Internet/intranet/extranet/software/computer networks/any other user interface that can be operated using a mouse, a touch pad, touch screen, voice interface of any other user interface to select options:
a. that functions as an independent website or
b. is hyperlinked to a compliant user interface (any website, password protected intranet, password protected extranet, software or any user interface that has adopted this interface and presents its hyperlinks in a buttons matrix) accessed using a standalone or any networked computing device, like a client computer, printer, server, router, switch or any other connecting node, that provides both input and output features through a button or a hyperlink—
i. consisting of buttons or other Graphical User Interface (GUI) components comprising of:
1. top row(s) consisting of an input box, and command buttons labeled such as “Search”, “Recent”, “Popular”, “Sort AZ”, “Sort ZA”, “Library”, “World”, “User's”, “Users” and other command buttons or Graphical User Interface (GUI) components and
2. left column(s) consisting of buttons and other command buttons or Graphical User Interface (GUI) components below the input box labeled alphabetically such as A, B, C or Aa, Ab, Ac . . . Ba, Bb, Bc . . . or numerically, and
3. The buttons matrix presents information resources in a user-friendly tree like structure emulating library classifications systems.

2. The buttons matrix proactively brings forth the valuable out-of-sight information resources from backend to the front-end presented to the users in a manner useful to the users in a user-friendly manner on a standalone or a networked computing device and also enables users to control how the information is presented to them in alphabetical order or by popularity or by how recently they were accessed or how much time is spent on such resources or by any other criteria that a user might be interested in through the use of Graphical User Interface (GUI) controls like buttons, radio buttons, check boxes, menus, dropdown menus, or input boxes, and
a. enables users to reconfigure the buttons matrix interface as per a user's preferences in terms of look and feel or in terms of functionalities e.g. a stock investor may reconfigure the interface to include stocks related information like market capitalization, price movements over a period, P/E ratio, Dividend yield etc., and
b. will have other command buttons or other Graphical User Interface (GUI) components hyperlinked to contemporary popular topics like images, videos, news, maps, travel, hotels, shop, weather, finance, music, horoscope, dating, exercise, yoga, weight loss, health, restaurants, politics, education, and user defined or user configured command buttons.

3. The buttons matrix will track users' favorite websites and visited websites and will help individual user and all users to access them while maintaining their due privacy by criteria like most recently (R) used, most frequently (F) used, or by most (M) time spent on them (in a nutshell doing RFM analysis) or such other relevant parameters that could be of interest to users.
